(19) United States
(12) Patent Application Publication
(10) Pub. No.: US 2012/0276527 A1
(43) Pub. Date: Nov. 1, 2012

(54) GENE RECOMBINATION SCREENING METHODS

(76) Inventor: Rick I. Cohen, Somerset, NJ (US)

(21) Appl. No.: 13/456,758

(22) Filed: Apr. 26, 2012

Related U.S. Application Data
(60) Provisional application No. 61/479,163, filed on Apr. 26, 2011.

(51) Int. Cl. G01N 21/64

(52) U.S. Cl. 435/6.1

(57) ABSTRACT

Methods and compositions for detecting recombination events are disclosed. Methods and compositions for expressing a gene of interest are also disclosed.

This application claims priority under 35 U.S.C. §119(e) to U.S. Provisional Patent Application No. 61/479,163, filed Apr. 26, 2011. The foregoing application is incorporated by reference herein.

### FIELD OF THE INVENTION

The present invention relates to the field of gene recombination. More specifically, the invention provides compositions and methods for the screening and identification of gene recombination events or pluripotency induction.

### BACKGROUND OF THE INVENTION

Several publications and patent documents are cited throughout the specification in order to describe the state of the art to which this invention pertains. Each of these citations is incorporated herein by reference as though set forth in full.

Current screening methods of recombination events, particularly with zinc finger nuclease technology, are slow. Methods which increase the speed of the screening method are desirable, particularly in the context of generating induced pluripotent stem cells or other induced cell types not requiring the adoption of pluripotency.

### SUMMARY OF THE INVENTION

In accordance with the present invention, methods for identifying recombination events and expressing proteins of interest are provided. In a particular embodiment, the method comprises recombining a nucleic acid molecule with the genome of a cell, wherein the nucleic acid molecule comprises at least one inducible promoter (e.g., a heat inducible promoter) and at least one reporter gene, wherein the inducible promoter is 5′ to the reporter gene, particularly in a non-coding region such as an intron; inducing the inducible promoter; and detecting the expression of the reporter gene, wherein the expression of the reporter gene is indicative of the recombination event. In a particular embodiment, the inducible promoter is the heat shock protein 70 promoter. In yet another embodiment, the nucleic acid molecule further comprises at least one splice signal and/or at least one reprogramming gene (e.g., a pluripotency inducing gene and/or transdiffereniating gene to induce differentiation of one cell type to a different cell type without pluripotency (e.g., a fibroblast directly into other differentiated cells such as a neuron)). In still another embodiment, the recombination step is performed using zinc finger nuclease technology.

### DETAILED DESCRIPTION OF THE INVENTION

The instant invention provides methods for screening for recombination events within a cell (e.g., somatic cell, stem cell, fibroblast, etc.) and/or expressing a protein of interest in a cell. In a particular embodiment, the method comprises inserting an inducible promoter within a non-coding region, particularly an intron. The inducible promoter may be, for example, a heat inducible promoter such as the heat shock protein 70 (HSP70) promoter. The inclusion of the HSP70 promoter within an intron allows for conditional expression of a newly recombined gene. For example, a recombinant gene that encodes a green fluorescent protein (GFP) after a natural or endogenous gene will only express the GFP when the entire recombinant gene is expressed. In contrast, the insertion of the HSP70 promoter in an intron allows the expression of only the portion of the gene which follows (is 3′ to) the HSP70 promoter. In a particular embodiment, the inducible promoter is inserted in the intron immediately 5′ to a reporter gene (e.g., by a donor nucleic acid comprising at least a portion of the endogenous gene comprising the promoter inserted into an intron followed by the reporter gene or comprising a gene of interest comprising the promoter inserted into an intron followed by the reporter gene). The HSP70 promoter may be induced, for example, by temperature (e.g., heat) shock, copper sulfate, stress, or toxic insult (e.g., geranylgeranyl acetate, STA-4783). For example, the cells may be heated to 42° C. form the normal 37° C. to turn on the expression from the new heat inducible promoter for screening purposes. The cells may then be returned to 37° C. to shut off the heat inducible promoter. This temperature range is for organisms that regulate their body temperature as humans, and can be altered based on their normal operating temperature.

The methods of the instant invention may be used, for example, to express genes of interest to screen zinc finger nuclease recombination, induce pluripotency, or for any other purpose requiring an inducible system with a very small genetic modification. In a particular embodiment, the HSP promoter is inserted into the intron prior to a newly inserted exon containing a novel fusion protein composed of a splice signal (e.g., the 2A splice signal from Foot and Mouth Disease Virus or other ribosome skipping motifs) together with a reporter. In a particular embodiment, the reporter gene is a fluorescent protein (e.g., GFP). In another embodiment, the reporter gene is also linked to a selectable marker. The instant system may be used to increase the speed of screening gene editing methodologies and recombination techniques such as ZFN mediated recombination (see, e.g., Sigma-Aldrich ZFN recombination technology (www.sigmaaldrich.com/life-science/zinc-finger-nuclease-technology/learning-center/what-is-zfn.html)), thereby saving time and resources. Further, shortening the time of screening keeps the cells from aging beyond the reprogramming window, thereby allowing users to generate induced pluripotent stem cells (IPSC) with minimal genetic modifications.

Zinc finger nucleases (ZFNs) bind DNA at user-specified locations and facilitate targeted editing of the genome by creating double-strand breaks in DNA. ZFNs comprise two functional domains: 1) a DNA-binding domain and 2) a DNA cleaving domain. The DNA binding domain (the zinc finger binding domains) may be engineered to recognize and bind to any nucleic acid sequence of choice (see, e.g., Beerli et al. (2002) Nat. Biotechnol., 20:135-141; Pabo et al. (2001) Ann. Rev. Biochem., 70:313-340; Isalan et al. (2001) Nat. Biotechnol., 19:656-660; Segal et al. (2001) Curr. Opin. Biotechnol., 12:632-637; Sera et al. (2002) Biochemistry 41:7074-7081; Choo et al. (2000) Curr. Opin. Struct. Biol., 10:411-416; Zhang et al. (2000) J. Biol. Chem., 275(43):33850-33860; Doyon et al. (2008) Nat. Biotechnol., 26:702-708; Santiago et al. (2008) Proc. Natl. Acad. Sci., 105:5809-5814; U.S. Patent Nos. 6,453,242; 6,607,882; and 6,534,261; www.zincfingertools.org; bindr.gdcb.iastate.edu/ZiFiT/; Mandell et al. (2006) Nuc. Acid Res., 34:W516-W523; Sander et al. (2007) Nuc. Acid Res., 35:W599-W605). The zinc finger binding domain may comprise at least one, particularly about four zinc finger recognition regions (i.e., zinc fingers). Zinc finger recognition regions and/or multi-fingered zinc finger proteins may be linked together using suitable linker sequences (e.g., linkers of five or more amino acids in length).

The DNA cleaving domain comprises a nuclease or an active portion/fragment thereof. In a particular embodiment, the nuclease is an endonuclease. The DNA cleaving domain may be derived from an enzyme that requires dimerization for cleavage activity. In other words, two zinc finger nucleases may be required for cleavage, as each nuclease comprises a monomer of the active dimer. When cleavage monomers are used, it is desirable to ensure that the recognition sites of the two zinc finger nucleases is such that the monomers are in a spatial orientation to each other that allows the monomers to form an active dimer. In a particular embodiment, the nuclease is Fok I, which is active as a dimer (Bitinaite et al. (1998) Proc. Natl. Acad. Sci., 95:10570-10575).

To mediate zinc finger nuclease genomic editing, at least one nucleic acid molecule (e.g., DNA or RNA (e.g., mRNA)) encoding a zinc finger nuclease and, optionally, at least one donor nucleic acid molecule are delivered to the cell of interest. The nucleic acid molecules may be delivered by any suitable method including, without limitation, transfection (e.g., calcium phosphate-mediated), electroporation, microinjection, lipofection, and the like. The expression of the ZFNs results in double-strand breaks within the genome, which in turn results in homologous recombination and non-homologous end joining (NHEJ). The donor polynucleotide may comprise upstream and downstream sequences, wherein the upstream and downstream sequences (e.g., from about 10 to about 50 or 100 or 500 or more nucleotides in length) share sequence similarity/homology (e.g., are at least 90%, 95%, 99% or 100% homologous) with either side of the site of integration in the chromosome, to allow for homologous recombination and insertion of the donor nucleic acid molecule into the genome at the site of cleavage by the ZFNs. As stated hereinabove, while the instant example describes the use of ZFNs, the methods of the instant invention may be used with other recombination and gene editing techniques.

As stated hereinabove, the inducible promoter may be a heat inducible promoter, such as the promoter of a heat shock protein. The heat inducible promoter may be induced by increasing the temperature or decreasing the temperature (e.g., cold shock promoter). The promoter may be from any species including, without limitation, virus, bacteria, yeast, fungi, frogs, flies, fish (e.g., deep water fish), mammals, humans, etc. In a particular embodiment, the species is human. In a particular embodiment, the promoter is the HSP70 promoter. Wu et al. (PNAS (1986) 83:629-633) provide an example of a sequence for the HSP70 promoter. The promoter may be derived synthetically or be derived/isolated from any heat sensitive promoter. The heat shock protein promoter may also be minimized to a small subset of nucleotides in place of the full length sequence. The promoters may also be modified to make them more or less active in the presence of other factors, such as serum or heavy metals. Notably, the HSP70 promoter may be activated in the presence of serum. The ZFN and IPSC generation paradigms use serum in the first screening or inducing stages, but serum is removed during the stem cell state. This circumvents any confounding signals introduced by the presence of serum as none is required once the ZFN or IPSC program is underway.

In accordance with the instant invention, the inclusion of an inducible promoter (e.g., within an intron) can be used to express at least one gene of interest. In a particular embodiment, the inducible promoter is used to express a reprogramming gene (e.g., a gene which promotes the generation of pluripotent stem cells (e.g., induce pluripotency) or a gene which causes direct differentiation from somatic cell to another cell type). The promoter can be used to express a set of genes or a polycistron of genes. In a particular embodiment, the inducible promoter controls the expression of at least one of Oct4, Sox2, KLF4, and c-Myc (or other myc replacements such as L-Myc, Glis1, or microRNA mimics). The instant invention also encompasses the expression of at least one gene which causes “trans-potency.” Trans-potency refers to the ability of a factor(s) to shift one cell from its native state to another differentiated (or progenitor) state without the need to go to the fully undifferentiated state of a human embryonic stem cell (hESC) or induced pluripotent stem cells (IPSC) (see, e.g., Kim et al. (2011) PNAS 108:7838-43).

In accordance with another embodiment of the instant invention, the inducible promoter may be inserted (e.g., via zinc finger nuclease (ZFN) technology) into natural gene loci to give the user the ability to induce the native gene upon demand using heat shock. In this regard, the HSP promoter can be inserted into the proximal end of the Oct4, Sox2, KLF4, and c-Myc promoters prior to the coding region of the gene. A reporter gene can be added followed by a 2A splice motif. This yields heat inducible native factors capable of inducing pluripotency.

While the use of FMDV 2A is exemplified hereinabove, other means for expressing multiple genes may be used. For example, multiple promoters may be operably linked to the genes' open reading frames (ORFs), splicing signals between genes may be inserted; proteolytic cleavage sites may be inserted between genes; and/or internal ribosomal entry sites (IRESs) may be inserted between genes. However, these typically require lengthy nucleotide sequences. For example, an IRES is usually longer than 500 nucleotides. However, the FMDV 2A peptide is a “self-cleaving” small peptide which has an average length of only 18-22 (typically 18) amino acids (Ryan et al. (1991) J. Gen. Virol., 72: 2727-2732) and results in the cleavage between the 2A peptide and its immediate downstream peptide (Kim et al. (2011) PLoS ONE 6(4): e18556; de Felipe, P. (2004) Gen. Vacc. Ther., 2:13; Fang et al. (2005) Nature Biotechnol., 23:584). Accordingly, the use of FMDV 2A is preferred, particularly when it is desired to make as small of an insertion into the genome as possible.

In a particular embodiment, the methods of the instant invention comprise delivering at least one nucleic acid molecule encoding at least one zinc finger nuclease and at least one donor nucleic acid molecule to a cell under conditions which allow for recombination. In a particular embodiment, the donor nucleic acid molecule comprises at least one inducible promoter and at least one reporter gene or marker gene. The inducible promoter may be operably linked to the reporter gene or marker gene and/or may be present in an intron (e.g., the intron immediately 5′ to the reporter gene). The donor nucleic acid molecule may further comprise at least one protein of interest encoding nucleic acid sequence. As stated hereinabove, the donor nucleic acid molecule may also comprise upstream and downstream sequences which hybridize with the target site in the genome. The donor nucleic acid molecule may further comprise nucleic acid sequences encoding for FMDV 2A. In a particular embodiment, the donor nucleic acid molecule comprises an inducible promoter operably linked to at least one protein of interest encoding nucleic acid and at least one reporter gene or marker gene, wherein said protein of interest encoding nucleic acid(s) and the reporter or marker gene(s) are each linked (e.g., directly) by a nucleic acid molecule encoding FMDV 2A such that the individual proteins are released upon translation. In a particular embodiment, the protein of interest is 5′ to the reporter or marker gene. In a particular embodiment, the protein of interest is a pluripotency inducer. The zinc finger nuclease may be targeted to any sequence of the genome, particularly a non-coding region such as an intron. In a particular embodiment, the zinc finger nuclease specifically targets/hybridizes to a single site to the general exclusion of other genome sequences.

In yet another embodiment, the donor nucleic acid molecule comprises an inducible promoter operably linked to at least one reporter gene or marker gene linked (e.g., directly) to a nucleic acid molecule encoding FMDV 2A at the 3′ end of the reporter gene or marker gene. This donor nucleic acid molecule may be delivered to a cell in combination with at least one nucleic acid molecule encoding at least one zinc finger nuclease, wherein the zinc finger nuclease is targeted to cleave 5′ (e.g., within about 50 nucleotides, within about 10 nucleotides, or immediately 5′) to the coding region of a gene of interest in the genome. The donor nucleic acid molecule may further comprise at least one protein of interest encoding nucleic acid sequence 5′ to the FMDV 2A for co-expression with the gene of interest in the genome.

The methods of the instant invention may further comprise detecting and/or isolating those cells which express the reporter or marker gene (after induction). The identified and/or isolated cells are those that have successfully had the donor nucleic acid molecule recombined with the cellular genome. The cells may then be induced to express the desired protein of interest by application of the appropriate stimulus (e.g., heat) at any desired time for a desired duration (e.g., for sufficient time to induce pluripotency).

### Definitions

The term “intron” refers to a DNA sequence present in a given gene that is not translated into protein and is generally found between exons. Introns are typically spliced out during mRNA maturation/processing.

The term “reporter gene” refers to a gene encoding a protein that may be assayed directly or indirectly. In a particular embodiment, the reporter can be directly assayed. Examples of reporter genes include, but are not limited to, bioluminescence catalyzing enzymes (e.g. luciferase), fluorescent protein (e.g., RFP (e.g., monomer red fluorescent protein), GFP (e.g., turboGFP (Evrogen; Russia))), chloramphenicol acetyltransferase, β-galactosidase, alkaline phosphatase, and horseradish peroxidase.

As used herein, the term “selectable marker” or “marker gene” refers to a gene which encodes an enzyme having an activity that confers resistance to an antibiotic or drug upon the cell in which the selectable marker is expressed. Examples of selectable markers include, without limitation, hygromycin phosphotransferase, blasticidin-S-deaminase (BSD), puromycin acetyltransferase (PAT), and neomycin phosphotransferase II (NPTII).

As used herein, an “inducible” promoter is one for which the transcription level of an operably linked gene varies based on the presence of a certain stimulus. The stimulus directs a level of transcription of an operably linked nucleic acid sequence that is higher or lower than the level of transcription of the operably linked nucleic acid sequence in the absence of the stimulus.

With reference to nucleic acids of the invention, the term “isolated” refers to nucleic acid molecules that are separated from sequences with which they are immediately contiguous in the naturally occurring genome of the organism in which they originated.

The phrase “operably linked”, as used herein, may refer to a nucleic acid sequence placed into a functional relationship with another nucleic acid sequence. Examples of nucleic acid sequences that may be operably linked include, without limitation, promoters, transcription terminators, enhancers or activators and heterologous genes which when transcribed and, if appropriate to, translated will produce a functional product such as a protein, ribozyme or RNA molecule.

As used herein, “reprogramming” refers to the conversion of a cell (e.g., a differentiated cell) into a less differentiated cell (e.g., pluripotent cell or stem cell) or a cell of a different type or lineage by introducing into the cell at least one reprogramming gene. Reprogramming encompasses dedifferentiation and transdifferentiation of somatic cells. Examples of reprogramming genes include, without limitation, Oct4, Sox2, Nanog, c-Myc, Klf4, and Lin28 and those provided in U.S. Patent Application Publication No. 2011/0171185 (see, e.g., Table 2).

What is claimed is:

1. A method for identifying recombination events, said method comprising:
a) recombining a nucleic acid molecule with the genome of a cell, wherein said nucleic acid molecule comprises at least one inducible promoter and at least one reporter or marker gene, wherein said inducible promoter is in an intron that is 5′ to said reporter gene;
b) inducing said inducible promoter; and
c) detecting the expression of said reporter or marker gene, wherein the expression of said reporter or marker gene is indicative of said recombination event.

2. The method of claim 1, wherein said inducible promoter is a heat inducible promoter.

3. The method of claim 2, wherein said heat inducible promoter is the heat shock protein 70 promoter.

4. The method of claim 2, wherein step b) comprises culturing the cell at a modulated temperature.

5. The method of claim 1, wherein said reporter gene is green fluorescent protein.

6. The method of claim 1, wherein said nucleic acid molecule further comprises at least one reprogramming gene.

7. The method of claim 6, wherein said reprogramming gene is selected from the group consisting of Oct4, Sox2, KLF4, and c-Myc.

8. The method of claim 1, wherein said nucleic acid molecule further comprises at least one protein of interest encoding nucleic acid sequence.

9. The method of claim 1, wherein step a) comprises delivering said nucleic acid molecule and a nucleic acid molecule encoding a zinc finger nuclease to said cell.

10. The method of claim 1, further comprising isolating the cell expressing the reporter or marker gene.

11. A method of inducing expression of a protein of interest in a cell said method comprising:
a) recombining a nucleic acid molecule with the genome of a cell, wherein said nucleic acid molecule comprises at least one inducible promoter, at least one reporter or marker gene, and a nucleic acid molecule encoding FMDV 2A, wherein said inducible promoter is operably linked to said reporter or marker gene, wherein said nucleic acid molecule encoding FMDV 2A is linked to the 3′ end of the reporter or marker gene, and wherein said recombination results in the insertion of the nucleic acid molecule 5′ to the coding region of the gene encoding said protein of interest in said genome;
b) inducing said inducible promoter; and
c) detecting the expression of said reporter or marker gene, wherein the expression of said reporter or marker gene is indicative of recombination and expression of said protein of interest.

12. A method of inducing expression of a protein of interest in a cell said method comprising:
a) recombining a nucleic acid molecule with the genome of a cell, wherein said nucleic acid molecule comprises at least one inducible promoter, at least one reporter or marker gene, at least one protein of interest encoding nucleic acid, and a nucleic acid molecule encoding FMDV 2A, wherein said nucleic acid molecule encoding FMDV 2A links the reporter or marker gene and the nucleic acid molecule encoding the protein of interest, and wherein said inducible promoter is operably linked to said reporter or marker gene and/or the nucleic acid molecule encoding the protein of interest;
b) inducing said inducible promoter; and
c) detecting the expression of said reporter or marker gene, wherein the expression of said reporter or marker gene is indicative of recombination and expression of said protein of interest.

13. The method of claim 11, further comprising isolating the cell expressing the reporter or marker gene.

14. The method of claim 12, further comprising isolating the cell expressing the reporter or marker gene.
